(19) United States
(12) Patent Application Publication
(10) Pub. No.: US 2010/0161128 A1
(43) Pub. Date: Jun. 24, 2010

(54) SYSTEM AND METHOD FOR CONTROLLING AUTOMATIC PARKING

(75) Inventors: Jeong Dan CHOI, Daejeon (KR); Byung Tae JANG, Daejeon (KR); Jaejun YOO, Daejeon (KR); Do Hyun KIM, Daejeon (KR); Jungsook KIM, Daejeon (KR); Kyeong Tae KIM, Daejeon (KR); Jae Han LIM, Daejeon (KR); Kyung Bok SUNG, Daejeon (KR); Jeong Ah JANG, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/484,565

(22) Filed: Jun. 15, 2009

(30) Foreign Application Priority Data
Dec. 22, 2008 (KR) 10-2008-0131663

(51) Int. Cl. G06F 7/00

(52) U.S. Cl. 700/258; 700/245; 901/1; 901/46

(57) ABSTRACT

An automatic parking control system includes a movable parking robot to load and carry a vehicle to be parked, a parking guide server for providing the parking robot with a moving path to the target parking space, and one or more posts, installed nearby an accessible parking area, for controlling a moving path of the parking robot in real time through communications with the parking robot.

### CROSS-REFERENCE(S) TO RELATED APPLICATION(S)

The present invention claims priority of Korean Patent Application No. 10-2008-0131663, filed on Dec. 22, 2008, which is incorporated herein by reference.

### FIELD OF THE INVENTION

The present invention relates to an automatic parking system and, more particularly, to a system and method for controlling automatic parking, in which a parking robot carries a vehicle depending on information on a target parking space and/or a moving path under the control of a guide post.

### BACKGROUND OF THE INVENTION

There are many vehicle drivers, especially beginner drivers, who are good at driving the vehicle but have a hard time parking properly. In fact, a number of reports have been made continuously on car collisions such as minor damage collisions that take place during parking the vehicle. Recently, it has been reported that a small mistake during parking may even cause slip and fall accidents. Moreover, most drivers have an experience in illegal parking due to the lack of time, etc. even though there is a parking lot they can use.

Valet parking is a parking service, provided by a person on behalf of a customer having difficulty in parking or being pressed for time or having other reasons, so as to move the customer's vehicle to a certain area like a parking lot. Usually, this parking service is available in particular places offering valets for drivers.

Some recently developed vehicles are equipped with a self-parking system that autonomously maneuvers the vehicles into a parking space, but their commercialization is proceeding with difficult for many reasons such as cost. In addition, in this case, they must control their power system directly, and thus, due to the possibility of an erroneous operation of the locking device which may occur after parking, the drivers should stay until the parking is completed. Moreover, such parked vehicles do not yet have a system necessary to take out of the parking space later.

### SUMMARY OF THE INVENTION

It is, therefore, an object of the present invention to provide a control system, parking robot, and post for automatic parking and method thereof, by which a power system of a vehicle to be parked is not directly involved, a smaller mechanical lifting device is adopted, and the vehicle can be automatically maneuvered into a target parking space, without any restriction on the specification of vehicle.

In accordance with one aspect of the present, there is provided an automatic parking control system, which includes: a movable parking robot to load and carry a vehicle to be parked; a parking guide server for providing the parking robot with a moving path to the target parking space; and one or more posts, installed nearby an accessible parking area, for controlling a moving path of the parking robot in real time through communications with the parking robot.

In accordance with another aspect of the present, there is provided a control method for automatic parking which includes: transmitting information on a moving path to a parking robot loaded with a vehicle upon receipt of a request for automatic parking; determining a moving speed and a rotation angle of the parking robot based on the moving path; if an obstacle is detected during the movement of the parking robot, controlling the moving path of the parking robot in real time to avoid the obstacle; and ending the control after the parking robot arrives at a target parking space.

### BRIEF DESCRIPTION OF THE DRAWINGS

The above and other objects and features of the present invention will become apparent from the following description of preferred embodiments, given in conjunction with the accompanying drawings, in which:

FIG. 1 shows a conceptual view of an automatic parking control system in accordance with one embodiment of the present invention;

FIG. 2 illustrates a flow chart for explaining the automatic parking control system in accordance with one embodiment of the present invention;

FIG. 3 presents a block diagram of the parking guide server shown in FIG. 2;

FIG. 4 depicts a block diagram of the parking robot shown in FIG. 2;

FIG. 5 provides a block diagram of the guide post shown in FIG. 2;

FIG. 6 illustrates a flow chart for explaining the operation of the post shown in FIG. 5;

FIG. 7 offers a block diagram of the detection sensor shown in FIG. 5; and

FIG. 8 illustrates a flow chart for explaining an automatic parking control method in accordance with one embodiment of the present invention.

### DETAILED DESCRIPTION OF THE EMBODIMENTS

Hereinafter, exemplary embodiments of the present invention will be described in detail with reference to accompanying drawings.

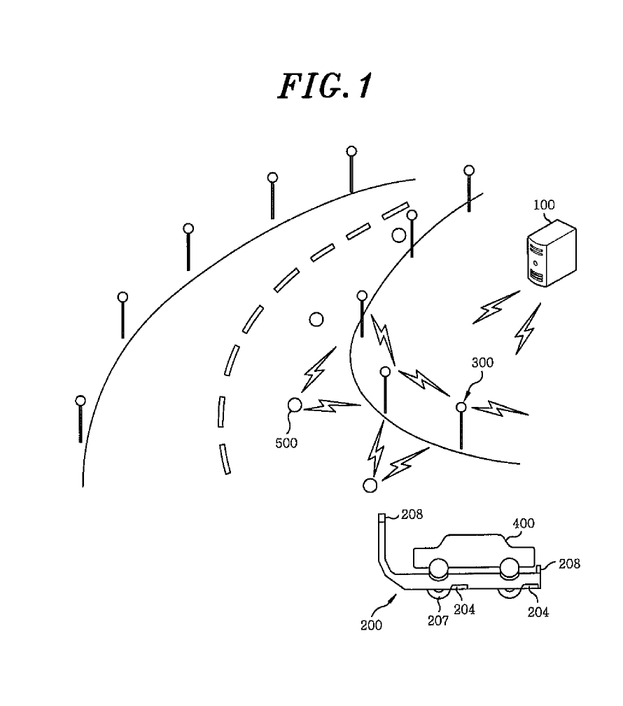

FIG. 1 shows a conceptual view of an automatic parking control system in accordance with one embodiment of the present invention.

The automatic parking control system shown in FIG. 1 includes a parking robot 200 that loads and carries a vehicle 400 to be parked, a parking guide server 100 for transmitting information on a target parking space (not shown) to the parking robot 200, and one or more posts 300 installed nearby an allowed parking for controlling a moving path of the parking robot 200 in real time through communication with the parking robot 200.

Herein, the target parking space indicates the final destination of the parking robot 200, or the location the vehicle 400 that is loaded on the parking robot is to be parked eventually, and the allowed parking area indicates the area that can be used as the target parking space of the vehicle 400.

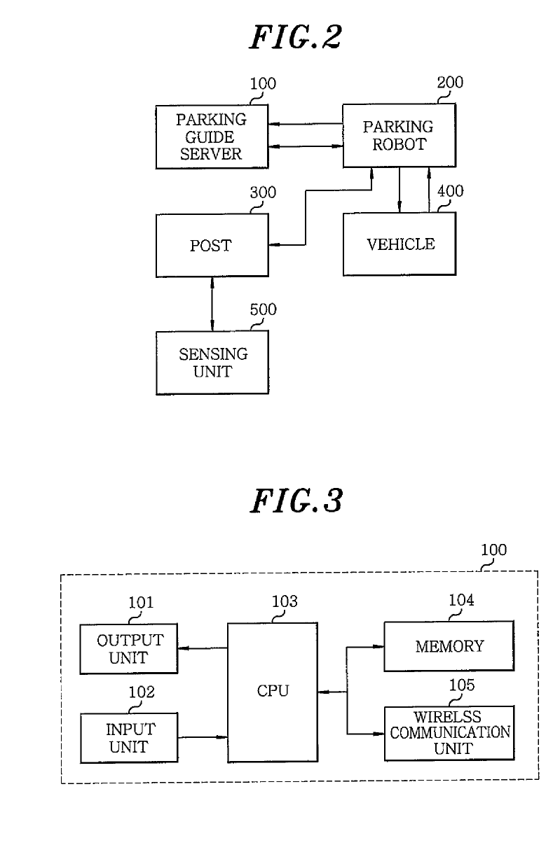

FIG. 2 illustrates a flow chart for explaining the automatic parking control system in accordance with one embodiment of the present invention.

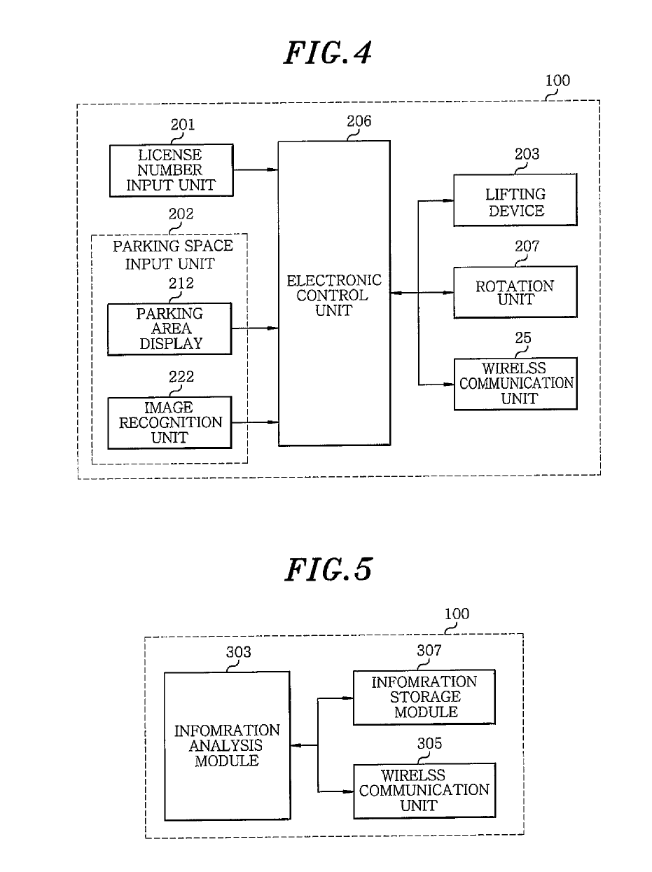

As shown in FIG. 2, the parking robot 200 loaded with the vehicle 400 receives information on a target parking space from the parking guide server 100. In this regard, the vehicle's driver may drive up his or her own vehicle 400 for its load onto the parking robot 200 in the first place, or the parking robot 200 may be connected to the vehicle 400 and then may lift the vehicle 400 with any suitable lifting device to place on its top. Although there is not explained in detail about how the parking robot 200 can place the vehicle 400 thereon, a wheel holding device, a piston, etc., or diverse constitutions that may be considered by those skilled in the art to which the automatic parking control system pertains may be adopted as the lifting device. For example, the lifting device may include a lifting device 203 that is under the control of an electronic control unit 206, as shown in FIG. 4.

Unloading the vehicle from the parking robot 200 is made in reverse order of the loading in which the parking robot 200 places the vehicle 400 on its top. That is, after maneuvering the vehicle 400 into the target parking space, the parking robot 200 can be disconnected from the vehicle 400. Once the parking operation is done, the parking robot 400 returns to the place where the vehicle 400 was loaded.

As illustrated in FIG. 4, it is also possible for the driver to select a desired parking spot as the target parking space out of the allowed parking area. In other words, the driver inputs the target parking space he or she desires through a target parking space input unit 202 and vehicle identification number such as the vehicle's license plate number through a vehicle license plate number input unit 201 so that he or she may select a location that requires a minimal amount of time to take out of the target parking space.

Details thereof will now be given by way of an example. First, provided inside the parking robot 200 are a vehicle license plate number input unit 201, a target parking space input unit 202, an electronic control unit 206 and a wireless communication unit 205. In this configuration, the driver first checks a target parking space he or she wants to park, through a parking area display 212 which displays accessible parking areas. If the driver touches a desired location on the screen, an image selected by the driver is recognized by an image recognition unit 222. Such recognized information is delivered to the electronic control unit 206, which in turn transmits it to the parking guide server 100 through the wireless communication unit 205.

Using the transmitted information, the parking guide server 100 decides whether the target parking space selected by the driver is available at present, and if so, it informs the parking robot 200 that the selected one has been determined as the target parking space. However, if the same target parking space is selected by two or more at the same time, or if the selected target parking space is currently occupied by something like a fixture, the parking guide server 100 informs the parking robot 200 that another target parking space needs to be inputted again. In such case, the same procedure described above is performed for the new target parking space again inputted by the driver.

Of course, it may be designed so that the process for deciding whether a target parking space selected by the driver is available at present may be omitted, and instead, the target parking space input unit 202 may display only parking spaces that are available at present for the driver to select and input a desired parking space among them.

As shown in FIG. 4, the description has been made with respect to the case where the parking robot 200 incorporates therein the vehicle license plate number input unit 201, the target parking space input unit 202, the electronic control unit 206 and the wireless communication unit 205, such that the driver can select his or her desired target parking space. However, this configuration may also be installed in a separate unit and especially the vehicle license plate number input unit 201 and the target parking space input unit 202 may be configured in an integrated unit, not in a separate physical unit.

Moreover, although not shown, there may be another configuration that issues to a driver a parking permit containing a target parking space selected by the driver and then determined (or designated) and the vehicle's identification number. Here, the parking permit may be a separate sheet of paper or a card or a storage medium with certain information stored therein.

In addition to the information related to the target parking space, the parking guide server 100 can also provide an optimal path from the current location of the parking robot 200 to the determined target parking space.

More specifically, the parking robot 200 informs the parking guide server 100 of its current location, that is, the location of the vehicle 400, and a central processing unit (CPU) 103 of the parking guide server 100 shown in FIG. 3 performs mapping onto the entire accessible parking areas and accessible moving paths, based on the transmitted information about the current location of the vehicle 400 and the determined target parking space, such that the parking robot 200 can be informed of an optimal path from the current location of the vehicle 400 to the target parking space.

The optimal path may be either a shortest path or a path with less parked vehicles.

Next, the parking robot 200 moves to the designated target parking space while communicating with the one or more posts 300 installed around an accessible parking area. If the parking robot 200 has already received a moving path from the parking guide server 100, the parking robot 200 simply follows the moving path provided from the parking guide server 100.

To be more specific, the parking robot 200 starts moving based on the moving path provided from the parking guide server 100. Provided that there is no obstacle on the path, the parking robot 200 would continue its journey along the path.

The parking robot 200 is also provided with a sensor 208 (see FIG. 1) for detecting other vehicles, pedestrian or other obstacles on the path, if any. The information of obstacles detected by the sensor 208, together with the current location of the parking robot 200, is transmitted to the posts 300.

In detail, the parking robot 200 has at least one sensor 208 to continuously detect obstacles that may exist on its way to the target parking space. For example, there may be obstacles, such as other vehicles being carried by other parking robots, or pedestrians or all kinds of objects on the path. If an obstacle is detected, a detection signal indicative of the obstacle detection is provided to the posts.

Each sensor 208 is preferably capable of detecting all obstacles within the range of 360 degrees of rotation with respect to the parking robot 200.

If an obstacle is detected, the parking robot 200 stops immediately or slows down. That is, the parking robot 200 measures the distance to an obstacle, and if the measured distance falls within a predetermined limit, it stops immediately.

In this case, as depicted in FIG. 5, the post 300 stores information on the obstacle's position in an information storage module 307 and analyzes a detour path for the parking robot 200 to be able to avoid the obstacle to transmit it to the parking robot 200 through the wireless communication unit 305.

The parking robot 200, which receives the detour path, moves to the path with the help of a movement control unit, e.g., a rotation unit 207 (see FIG. 4), and returns to its original path after taking a detour.

Here, the movement control unit is built to control the movement including the speed and the moving direction of the parking robot 200. For instance, if the parking robot 200 moves by rolling wheels, the movement control unit can control the toe angle of a wheel in the length direction of the parking robot 200 and the rotation speed of a wheel. The toe angle can be controlled by the control of steering of a wheel, and the rotation speed of a wheel can be controlled based on information from a speed-meter that is generally installed in a vehicle. To this end, the parking robot 200 is provided with the rotation and speed sensors 204 (see FIG. 1).

Although it has not been explained in detail, when the parking robot 200 does not receive the moving path from the parking guide server 100, it can be directed to the moving path, by taking it from the posts 300, that is, only through communications with the posts 300.

In addition, as shown in FIG. 1, each sensing unit 500 may be further fixedly installed at regular intervals along the moving path of the parking robot 200. That is, in addition to the detection of any obstacle on the moving path made by the sensors 208 built in the parking robot 200, when the detection sensors 500 fixedly installed along the moving path accessible by the parking robot 200 detect parked vehicle(s) or obstacle(s) on the moving path, the posts 300 may provide the parking robot 200 with a detour path in consideration of those path situations.

For example, a wireless magneto-resistive sensor as illustrated in FIG. 7 may be employed as each of the sensing unit 500. For this, the sensing unit 500 is constituted by an RF 501, a power supply 502, a micro control unit (MCU) 503, a magneto-resistive sensor 506 for detection in association with the MCU 503, a memory 504 and a wireless communication unit 505 for transmitting detected information to the posts 300.

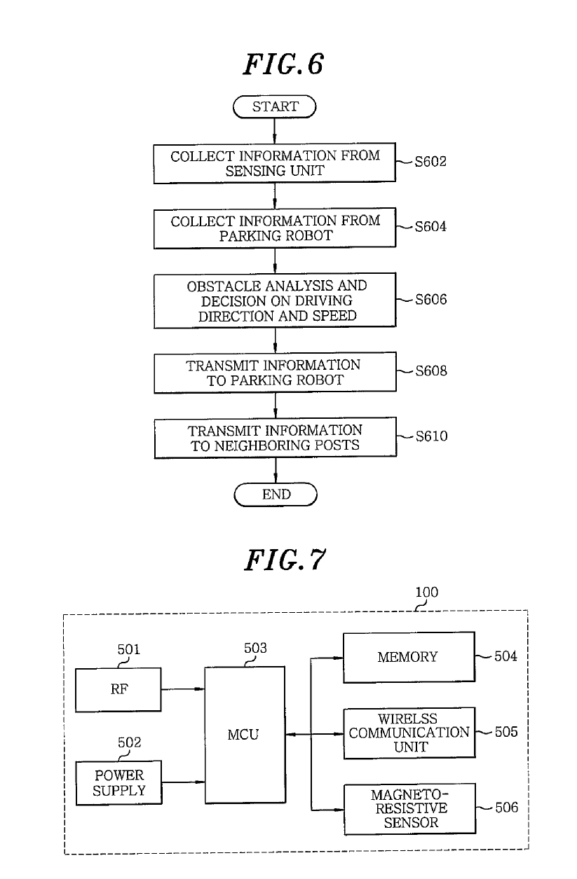

The operation flow of the post 300 will now be described with reference to FIG. 6. First, in step S602, the post 300 collects information from the sensing unit 500 about parked vehicle(s), obstacle(s), etc., and in step S604, collects information from the parking robot 200 about various obstacles. Based on the information, in step S606, the post 300 analyses the obstacles and decides whether to avoid the obstacles, so as to determine the driving direction for a detour and the speed the parking robot 200 should take. Then, in step S608, the post 300 transmits the detour information to the parking robot 200.

If there are two or more posts 300, the information is also shared with other neighboring posts 300, and those posts 300 that have received the information store them in their information storage module 307 in step S610. Needless to say, the information stored in the information storage module 307 of each of the posts 300 can be updated.

In this manner, the parking robot 200 safely maneuvers the vehicle 400 into the target parking space, and then returns to the location where it originally loaded the vehicle and awaits for the next process. To be more specific, the parking robot 200 follows the vehicle loading procedure in opposite order to safely unload the vehicle 400 in the target parking space, and returns to the location, guided by communications with the posts 300 or the parking guide server 100, where it originally loaded the vehicle 400. That is, the location to which the parking robot 200 must return, indicating the location where the parking robot 20 originally loaded the vehicle 400, is predetermined, and the other steps in the flow remain roughly the same.

In the automatic parking control system in accordance with of the present invention, transmission/reception of information between the parking guide server 100, the parking robot 200 and the posts 300 is done wirelessly. Also, this may be done by a proper combination of wired and wireless schemes.

The following is a detailed description about the parking robot 200.

As shown in FIGS. 1 and 4, the parking robot 200 moves with the vehicle 400 loaded thereon, until it arrives at the final destination, i.e., the target parking space, by receiving information from the parking guide server 100 about the target parking space and the moving path and by the real-time control through communications with the posts 300.

A more specific example of the parking robot 200 will now be discussed. As described earlier, the parking robot 400 loads the vehicle 400 using the lifting device 203 and receives the vehicle's identification number such as the vehicle's license plate number from the driver through the vehicle license number input unit 201. If the parking robot 200 is designed to let the driver select a target parking space as well, it receives information on the target parking space through the target parking space input unit 202 and then transmits it to the parking guide server 100 (see FIG. 1) via the wireless communication unit 205, and receives information from the parking guide server on whether the target parking space has been determined and information on the moving path. Moreover, under the control of the electronic control unit 206, the parking robot 200 transmits information on obstacle(s) to the posts 300 via the wireless communication unit 205, and receives information from the posts 300 on the detour path and the like, while moving to the target parking space.

Now, details of the posts 300 in accordance with one embodiment of the invention will be given with reference to FIGS. 1 and 5.

Each of the posts 300, as shown in FIGS. 1 and 5 communicates with the parking robot 200, and includes an information analysis module 303, a wireless communication unit 305 and an information storage unit 307.

The information analysis module 303 of the post 300 analyzes a detour path based on the information and transmits it to the parking robot 200 via the wireless communication unit 305, thereby controlling the moving path of the parking robot 200 in real time. Here, the information analysis module 303 may obtain the obstacle detected information directly from the sensors 208, or from other neighboring posts 300.

In addition, the sensing unit 500 is also installed along the moving path of the parking robot 200 to provide the parking robot 200 with information about parked vehicle(s), fixed obstacle(s), etc., which are within its detection range to perform the real-time control over the parking robot 200.

Moreover, as mentioned above, even though communications between the parking robot 200 and the sensors are done via the wireless communication unit 305, a combination of wired/wireless means may also be used.

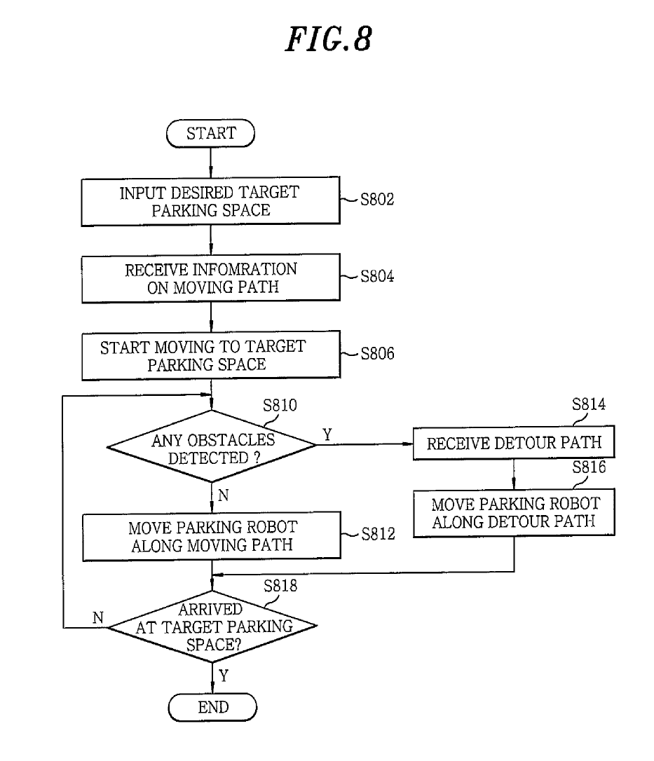

Now, the automatic parking control method in accordance with one embodiment of the present invention will be described in detail with reference to FIG. 8.

First, when a driver requests automatic parking in step S802 and inputs the target parking space in step S804, the parking robot 200 loaded with the vehicle 400 receives a moving path in step S806.

Subsequently, the parking robot 200 determines its moving speed and rotation angle on the basis of the moving path, and starts moving accordingly in step S808.

To transmit information on the moving path to the parking robot 200 loaded with the vehicle 400, any computer equipped with CPU, as in the parking guide server 100, may be used. For example, if the parking robot 200 has wheels, the moving speed and the rotation angle of the parking robot 200 can be determined by the spinning speed of each wheel, and by the axial rotation angle of each wheel.

Next, in step S810, it is determined that any obstacle is present on the way of the parking robot 200 through the use of the sensors 208. If an obstacle is not detected, a control process goes to step S12 where the parking robot 200 moves its moving path.

However, if an obstacle is detected, a control process goes to step S814. In step S814, the parking robot 200 receives a detour path that is analyzed to avoid the obstacle under the real-time control operation. This is accomplished by the posts 300 installed at regular intervals nearby the accessible parking area. Thereafter, in step S816, the parking robot 200 travels along the received detour path.

Thereafter, the automatic parking control method is completed when the parking robot 200 has arrived at the target parking space in step S818.

The control system, parking robot, and post for automatic parking and method thereof in accordance with the present invention described so far have mainly focused on the case where the parking robot maneuvers a vehicle into the target parking space, but it should be understood by those ordinary skills in the art that the above procedure may be implemented in reverse order to take the parked vehicle out of the parking space.

In accordance with the control system, parking robot, and post for automatic parking and method thereof of the present invention, a vehicle can be moved autonomously without using the power of the vehicle directly such that all vehicles, regardless of features and specifications of individual vehicles, can be parked automatically, and the mechanical lifting device can be minimized, and illegal parking of any reason (e.g., insufficient time for the drivers to park in a proper lot) can be prevented.

In addition, the present invention can reduce any risk that may occur during parking or by another vehicle on a path for parking, prevent damages on the vehicles, and reduce the cost of the automatic parking control system.

While the invention has been shown and described with respect to the particular embodiments, it will be understood by those skilled in the art that various changes and modification may be made without departing from the scope of the present invention as defined in the following claims.

What is claimed is:

1. An automatic parking control system, the system comprising:
a movable parking robot to load and carry a vehicle to be parked;
a parking guide server for providing the parking robot with a moving path to the target parking space; and
one or more posts, installed nearby an accessible parking area, for controlling a moving path of the parking robot in real time through communications with the parking robot.

2. The system of claim 1, wherein the parking robot includes a sensor for detecting the presence of an obstacle on the moving path, and
wherein if an obstacle is detected by the sensor, obstacle detected information is transmitted to the posts.

3. The system of claim 1, wherein the parking robot includes:
a movement control unit for controlling the speed and direction of the parking robot; and
a lifting device for lifting the vehicle,
wherein each of the posts transmits, to the parking robot, control information to control the moving path of the parking robot in real time based on moving location of the parking robot and the obstacle detected information provided from the parking robot.

4. The system of claim 1, wherein the parking robot returns to a location to which it loaded the vehicle after safely maneuvering the vehicle into the target parking space.

5. The system of claim 1, further comprising:
one or more sensing unit provided on the moving path, for providing information on the presence of an obstacle in the moving path to the parking robot through the post.

6. The system of claim 1, further comprising:
a target parking space input unit for providing information on the target parking space to the parking guide server, and
an identification number input unit for providing an identification number of the vehicle to the parking guide server.

7. A control method for automatic parking comprising:
transmitting information on a moving path to a parking robot loaded with a vehicle upon receipt of a request for automatic parking;
determining a moving speed and a rotation angle of the parking robot based on the moving path;
if an obstacle is detected during the movement of the parking robot, controlling the moving path of the parking robot in real time to avoid the obstacle; and
ending the control after the parking robot arrives at a target parking space.

8. The control method of claim 7, further comprising:
receiving information on a desired target parking place from the vehicle; and
transmitting, to the parking robot, a moving path from the current location of the vehicle to the desired target parking place.

9. The control method of claim 8, further comprising:
if the desired target parking space coincides with another desired target parking space requested from another vehicle, requesting said another vehicle that inputted another desired target parking space later to re-input another desired target parking space.

10. The control method of claim 7, wherein the transmission and reception of the information are done wirelessly.
